(19) United States
(12) Patent Application Publication
(10) Pub. No.: US 2026/0329644 A1
(43) Pub. Date: Oct. 22, 2026

(54) METHOD AND APPARATUS FOR TASK SCHEDULING USING SELF ELECTION

(71) Applicant: VERIZON PATENT AND LICENSING INC., Basking Ridge, NJ (US)

(72) Inventors: Kabilan KUMARAVELU, Erode (IN); Ramkumar NARASIMHACHARY, Chennai (IN); Sravanth DEVI, Chennai (IN); Kalaiarasan MANIMARAN, Mayiladuthurai (IN)

(73) Assignee: VERIZON PATENT AND LICENSING INC., Basking Ridge, NJ (US)

(21) Appl. No.: 19/184,044

(22) Filed: Apr. 21, 2025

(51) Int. Cl. G06F 9/50

(52) U.S. Cl. CPC G06F 9/5027

(57) ABSTRACT

Techniques for self-scheduling tasks by processes are disclosed. In one embodiment, a computerized method performed by a number of processes of a number of computing device is disclosed comprising identifying, by each of the number of processes, a task awaiting execution, determining, by each of the number of processes, a shared storage location for the identified task, updating, by each of the number of processes, the shared storage location determined for the identified task with process identification information uniquely identifying the updating process, each process's update overwriting any process identification information stored in the shared storage location, and accessing, by each of the number of processes, the shared storage location and retrieving the process identification information stored in the shared storage location, the retrieved process identification information identifying the process self-electing itself to execute the identified task.

### BACKGROUND INFORMATION

In computing environments, such as a distributed, microservices, etc. environments, processes are assigned to execute tasks using a dedicated scheduler. Unfortunately, as the number of tasks increases, the scheduler can become overwhelmed and cause tasks to be unassigned, which can lead to processing delays, performance issues, resource allocation issues, and the like.

### BRIEF DESCRIPTION OF THE DRAWINGS

FIG. 1 provides an example illustrating components of an elector engine used in self-election in accordance with embodiments of the present disclosure;

FIGS. 2A and 2B provide an example of a schematic diagram illustrating self-election stages in accordance with one or more disclosed embodiments;

FIG. 3 provides a self-election process flow in accordance with one or more embodiments of the present disclosure; and

FIG. 4 provides a block diagram illustrating a computing device showing an example of client or server device used in accordance with one or more embodiments of the present disclosure.

### DETAILED DESCRIPTION OF EXAMPLE EMBODIMENTS

Improved techniques for self-scheduling tasks by processes are disclosed. In accordance with disclosed embodiments, available processes can use self-election to nominate themselves to execute a task rather than using a dedicated scheduler. Embodiments of the present disclosure enable each process to act as its own scheduler thereby eliminating the need for a dedicated scheduler and avoiding the processing delays, performance issues, resource allocation issues, or other issues associated with a dedicated scheduler.

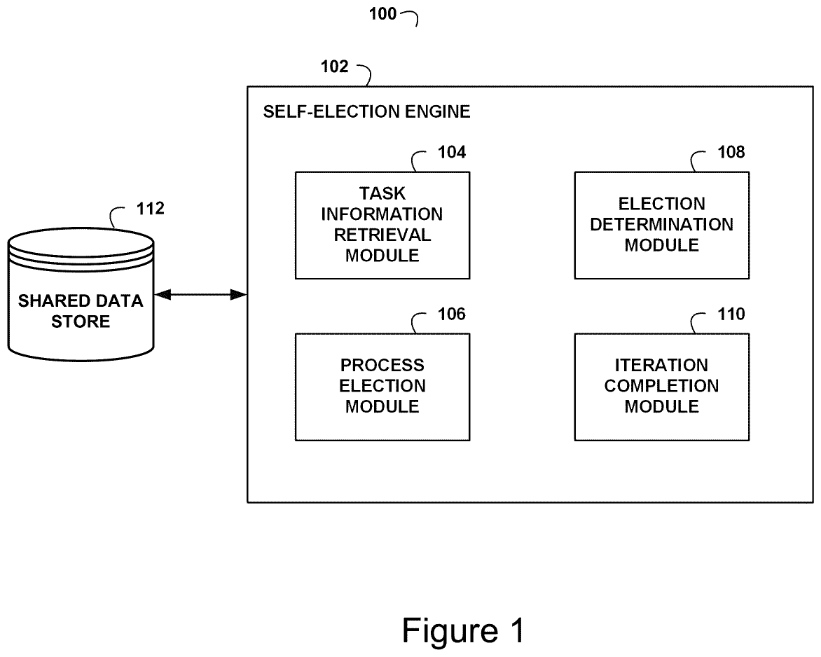

FIG. 1 provides an example illustrating components of a self-election engine in accordance with one or more embodiments. In accordance with disclosed embodiments, each of number of processes can execute self-election engine 102 to self-elect, or nominate, itself to execute a task from a set, or queue, of tasks. The process that successfully self-elects a task can then execute the task, while each process that is unsuccessful in the election of that particular task can attempt to perform self-election in connection with another task from the task queue, e.g., in connection with another self-election iteration. In accordance with one or more embodiments, self-election can be an iterative process where one process from a number of available processes self-elects a task from the task queue in a given iteration.

By way of a non-limiting example, in a multi-server architecture in which each of a number of servers can be executing a number of processes, embodiments of the present disclosure can be used to identify which process in the multi-server architecture is to execute a given task in a set, or queue, of tasks. As discussed herein, in a given self-election iteration, each process that is available to execute a task can use self-election engine 102 to self-elect itself to execute the task. And, across the number of servers, one of the self-electing processes executing on one of the number of servers can successfully self-elect itself to execute the task. It should be apparent that embodiments of the present disclosure can be used with any number of processes of any number of servers, computing devices, processors, etc.

In accordance with one or more embodiments, self-election engine 102 can comprise a task information retrieval module 104, process election module 106, election determination module 108 and an iteration completion module 110. As shown in example 100, engine 102 can access shared data store 112. As discussed in more detail below, shared data store 112 can be accessed by each process involved in self-election.

Shared data store 112 can comprise information about each task awaiting execution by a process, the processes available to execute a task and self-election, or election, information. As discussed in more detail below, election information can comprise information indicating a shared storage state and information uniquely identifying a self-electing process. Shared storage state information can comprise a value that can be used to identify a state of a shared storage location associated with a task. As is discussed in more detail below, self-election can comprise a number of stages and the shared storage state can change from one stage to another. In accordance with one or more embodiments, the information uniquely identifying a self-electing process can comprise identification information, e.g., a signature, uniquely identifying the self-electing process.

In example 100, shared data store 112 is shown as a single data store. In accordance with one or more embodiments, shared data store 112 can comprise shared memory. It should be apparent that multiple, different shared data stores can be used in connection with disclosed embodiments. By way of some non-limiting examples, shared data storage 112 can be a key-value database (e.g., Redis™, Oracle Coherence™, etc.), a relational database (e.g., Oracle Database™, MySQL™, etc.), a non-relational database, etc.

In example 100, module 104 can retrieve information about a task from shared data store 112. The task can be one of a number of tasks in a task queue awaiting assignment to a process for execution. The retrieved task information can comprise task identification information. Process election module 106 can use the task information retrieved from shared data store 112 to determine a shared storage location within shared data store 112 used to store self-election information in connection with a respective process and task.

In accordance with one or more embodiments, each respective process, of a number of available processes, can elect, or nominate, itself to execute a task by accessing a same, unique location in shared data store 112 uniquely associated with the task and writing election information to the shared storage location. As discussed, the election information can comprise information identifying a state of a shared storage location associated with a task and information uniquely identifying the process writing to, or updating, the shared storage location.

Using module 106, by updating the shared storage location, one process can overwrite another process's update to the shared storage location. By overwriting another process's election information, a process effectively overwrites the other process's unique identification information, knocking the other process out of contention to be the self-electing process. Advantageously, by allowing one process to overwrite another process's unique identification information in the shared storage location, there is no need to implement/use a locking mechanism. Issues typically associated with locking mechanisms, such as and without limitation, additional processing overhead, resource deadlocks, etc. can be avoided. In accordance with one or more disclosed embodiments, the process whose unique identification information is retained in the shared storage location becomes the process that effectively self-elects, or assigns itself, to execute the task. By way of a non-limiting example, the process that accesses and updates the shared storage location with its unique identification information last can become the process self-electing execution of the task.

In accordance with one or more embodiments, a process can use module 108 of engine 102 to confirm whether or not it successfully nominated itself. Using module 108, a process can access a task's unique shared storage location in shared data store 112, retrieve the election information stored in the shared storage location, and make a determination whether the retrieved election information includes the process's unique identification information, or another process's unique identification information.

Each process can use unique identification information retrieved by module 108 from a task's shared storage location to identify the process that successfully elected itself to execute the task. As is discussed in more detail below, in accordance with one or more embodiments, each process can also use module 108 to access the shared storage location unique to the task and update the shared storage location with the unique identification information of the process that successfully self-elected itself along with memory state information, freezing any changes to the identity of the self-electing process in the shared storage location and indicating that self-election is complete in connection with the task.

Iteration completion module 110 can be configured to cause a process that successfully self-elected to execute the task, or cause a process that unsuccessfully self-elected to return to the pool of available processes 210 to participate in another iteration involving another queued task.

In accordance with one or more embodiments, self-election can be iteratively performed, where a process from a set of available processes elects to execute a task from a set, or queue, of tasks in each iteration. In accordance with one or more embodiments, a self-election iteration can involve a set of self-election stages-e.g., a process election (or first) stage, an election determination (or second) stage and an iteration completion (or third) stage.

In accordance with one or more embodiments, a period of time can be associated with each stage. By way of a non-limiting example, a first time period associated with the process election stage can permit each of the available processes 210 to update a task's shared storage location with election information in an attempt to self-elect itself, a second time period associated with the election determination stage can permit each of the available processes 210 to retrieve the election information retained in the task's shared storage location after expiration of the first time period, and a third time period associated with the iteration completion stage can permit each of the available processes 210 to update the task's shared storage location with election information including process identification information uniquely identifying the process that successfully self-elected.

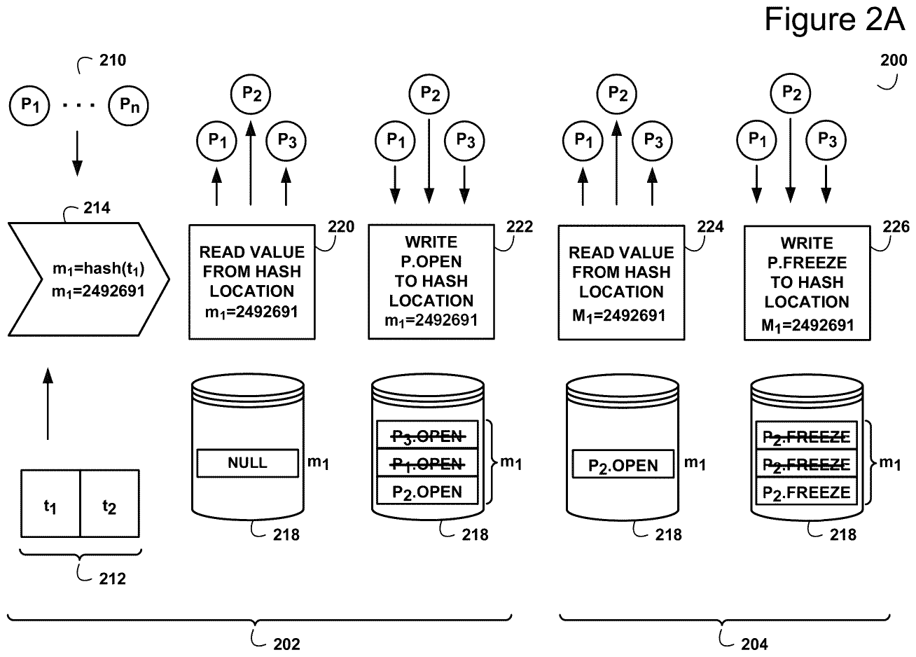

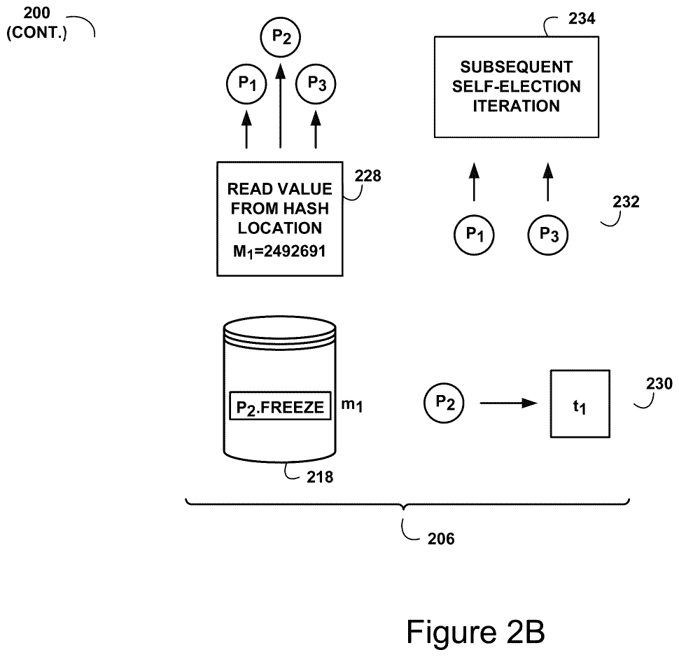

FIGS. 2A and 2B provide an example of a schematic diagram illustrating self-election stages in accordance with one or more disclosed embodiments. In example 200 of FIGS. 2A and 2B, process election stage, election determination stage and iteration completion stage correspond to reference numbers 202, 204 and 206, respectively.

In accordance with one or more disclosed embodiments, modules 104 and 106 of engine 102 can be configured to operate process election stage 202, module 108 can be configured to operate election determination stage 204 and module 110 can be configured to operate iteration completion stage 206. In accordance with one or more embodiments, each one of the available processes 210 can execute engine 102. In stage 202, at step 214, each one of the available processes 210 can use module 104 to access a shared data store, e.g., shared data store 112, and retrieve task information associated with a task, e.g., task t₁ of task queue 212.

In shown in example 200, at step 214, some or all of the retrieved task information associated with task t₁ can be used by each one of the available processes 210 to determine a location in shared data store 112 that is uniquely associated with task t₁—e.g., shared storage location, m₁ of data store 218. As shown in example 200, a hash function can be used with retrieved task information associated with task t₁ to determine the shared storage location, m₁, for task t₁.

In accordance with one or more embodiments, shared storage location m₁ can store a state of the shared storage location identified for the task t₁. In accordance with one or more embodiments, in an initial (or first) shared storage state, a “NULL” value at the storage location indicates the initial state of the shared storage location. The initial value can further indicate, or confirm, that self-election has not commenced in connection with task t₁. The initial value can be indicative of a case in which the process election (or first) stage of self-election has not commenced and none of the available processes 210 has nominated itself to execute the task.

In accordance with one or more embodiments, another value, such as “OPEN”, can be used to identify a second shared storage state corresponding to the process election (or first) stage and election determination (or second) stage of self-election, and a third value, e.g., “FREEZE”, can be used to identify a third shared storage state corresponding to the election determination (or second) and iteration completion (or third) stages of self-election.

In accordance with one or more embodiments, a shared storage state value can be included in the election information written to a task's shared storage location in any of the stages of self-election. As discussed herein, the second shared storage state value, e.g., “OPEN”, can indicate that self-election has commenced and that at least one process has elected itself to execute the task, and the third shared storage state value, e.g., “FREEZE”, can indicate that self-election is complete—i.e., no longer open for self-election. As is discussed, election information can further include information uniquely identifying the self-electing process that wrote the election information stored at the shared storage location. In the third shared storage state, the election information stored in the shared storage location can comprise information uniquely identifying the self-electing process that has “won” self-election- or successfully elected itself to execute the task.

Available processes 210 are shown in example 200 as processes p₁-p₃. It should be apparent that there can be any number of processes available to participate in stages 202, 204 and 206. At step 220, available processes 210 access shared data store 218 and read the election information comprising the shared storage state value stored at location m₁, which is the shared storage location that is uniquely associated with task t₁. At step 220, the “NULL” value found at location m₁ indicates that self-election has not yet begun in connection with task t₁, and none of the available processes 210 has nominated itself. The “NULL” value can be used as an indicator to the available processes 210 that they can self-elect to execute task t₁.

At step 222, each one of the available processes 210 can nominate itself to execute task m₁ by accessing data store 218 and updating shared storage location m₁ with election information comprising its unique process identification information and the “OPEN” value indicating the second shared storage state. In example 200, process p₁ is the first of the available processes 210 to self-elect itself by writing it unique process identification information, e.g., a signature, along with the value of “OPEN”. In example 200, the unique process identification information is indicated as pₙ.

As the next process to write its election information to shared storage location m₁, process p₃ overwrites, or replaces, the election information written by process p₁ by writing its election information comprising its unique process identification information and the shared storage location state value of “OPEN”. Process p₂ is the next to update storage location m₁, overwrites the election information written to shared storage location m₁ by process p₃ with its own election information comprising its unique process identification information and the shared storage state information comprising the value of “OPEN.” In example 200, process p₂ is the last process to write election information to shared storage location m₁ in the process election (or first) stage of self-election.

At step 224, each one of the available processes 210 can use module 108 and determine which one of the available processes 210 successfully elected, or nominated, itself to execute task t₁. In example 200, in the election determination (or second) stage of self-election, the election information stored at shared storage location m₁ can be retrieved by each one of the available processes 210 and used to identify the process that successfully elected, or nominated itself. In example 200, the election information stored at shared storage location m₁, which was written by process p₂ and identifies process p₂ as the process that successfully self-elected to execute task t₁, can be retrieved by each one of available processes 210.

At step 226, each one of the available processes 210 can use module 108 to confirm that self-election is closed and that process p₂ is the self-electing process by writing election information to shared storage location m₁ comprising information uniquely identifying process p₂ along with the value “FREEZE” indicating the third shared storage state.

Referring to FIG. 2B, at step 228, each one of the available processes 210 can use module 108 to access data store 218, read the information stored in shared storage location m₁ and confirm that shared storage location m₁ has been updated in accordance with the determined self-election outcome.

In accordance with one or more embodiments, each one of the available processes 210 can use iteration completion module 110 to determine how to proceed. As shown in example 200, with reference to FIG. 2B, process p₂ can proceed with executing task t₁ at step 230, while processes p₁ and p₃ can return to a pool of available processes 210 and proceed with a subsequent self-election iteration 234 at step 232. Although not shown in FIG. 2A or 2B, after executing task t₁, process p₂ can become one of the available processes 210 participating in a subsequent self-election iteration 234.

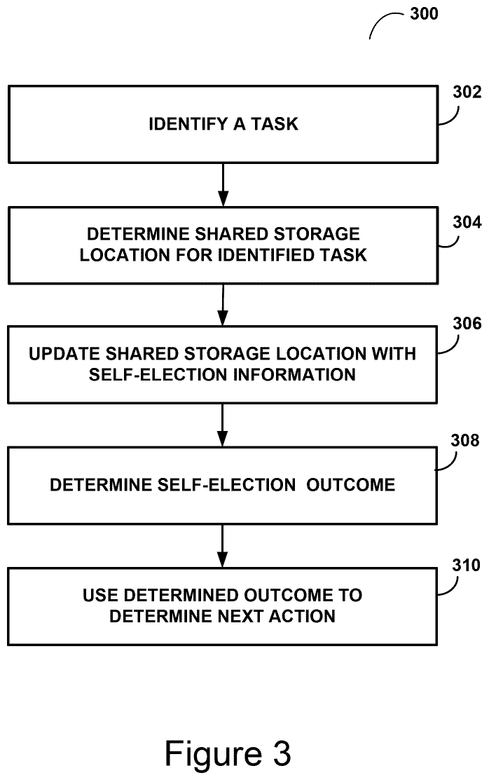

FIG. 3 provides a self-election process flow in accordance with one or more embodiments of the present disclosure. By way of a non-limiting example, process flow 300 can be performed by each process, e.g., each one of available processes 210, executing self-election engine 102 to self-elect, or nominate itself, to execute a task, e.g., one of the tasks in task queue 212. In accordance with one or more embodiments, process flow 300 can be iteratively performed, such that one of available processes 210 self-elects to execute a queued task with each iteration.

At step 302, a task can be identified. By way of a non-limiting example, the identified task can be a task, in a task queue (e.g., queue 212), which is awaiting execution by an available process, e.g., one of available processes 210. Step 302 can be performed by task information retrieval module 104 of self-election engine 102. With reference to FIG. 1, information about a task awaiting execution can be retrieved from shared data store 112 and used to identify a task from a set of tasks.

Referring again to FIG. 3, step 304, a shared storage location can be determined for the identified task. By way of a non-limiting example, step 304 can be performed by process election module 106. In accordance with one or more embodiments, module 106 can use some or all of the task information retrieved from shared data store 112, at step 302, to determine a shared storage location within shared data store 112. By way of a non-limiting example, a hash function can be used with retrieved task information associated with a task, such as task t₁, to determine a shared storage location, m₁, for task t₁.

At step 306, the shared storage location can be updated with self-election information. By way of a non-limiting example, each of available processes 210 can use module 106 to write self-election information to the shared storage location determined for the identified task at step 304. In accordance with one or more embodiments, the self-election information can comprise information uniquely identifying the updating process and an shared storage state.

As discussed connection with FIGS. 2A and 2B, in accordance with one or more embodiments, shared storage location m₁ can store a value indicating a state of the shared storage location m₁ in connection with the task t₁. A process that writes information indicating the shared storage state can also write information uniquely identifying itself. In a first shared storage state, the shared storage state information can include a value, e.g., a “NULL” value, indicating that self-election has not yet begun in connection with task t₁ and none of the available processes 210 has nominated itself to execute the task.

In a second shared storage state, the shared storage information can include a value, e.g., “OPEN” value, indicating that self-election has commenced and that at least one process has elected itself to execute the task. In a third shared storage state, the shared storage state information can include a value, e.g., a value of “FREEZE”, indicating that self-election is complete—i.e., no longer open for self-election.

In the second and third shared storage states, the stored value can include information, e.g., a signature, uniquely identifying a self-electing process updating the shared storage location. In the second shared storage state, the information uniquely identifying a self-electing process identifies the most recent (or possibly last) self-electing, or nominating, process to update the shared storage location. In the third shared storage state, the information uniquely identifying a self-electing process identifies the self-electing process that has “won” or successfully elected itself to execute the task.

As discussed herein, including in connection with FIGS. 2A and 2B, each one of the available processes 210 can access a task's shared storage location to write its own election information to effectively nominate itself to execute the identified task. Each time a process writes its election information to the task's shared storage location, it overwrites any data, e.g., any election information written by another self-electing process, which was previously stored in the shared storage location.

With reference example 200, at step 222, each one of the available processes 210 can nominate itself to execute task m₁ by accessing data store 218 and updating shared storage location m₁ with its election information that can include process identification information that uniquely identifies the self-electing process and the “OPEN” shared storage state value. In example 200, process p₁ is the first of the available processes 210 to update shared storage location m₁, process p₃ is the next one of the available processes 210 to update shared storage location m₁ and overwrite the election information written to shared storage location m₁ by process p₁, and process p2is the third one of the available processes 210 to update shared storage location and overwrite the update to shared storage location m₁ made by process p₃. In example 200, process p₂ is the most recent (as well as the last in example 200) process to update shared storage location m₁.

Referring again to FIG. 3, at step 308, a self-election outcome can be determined. By way of a non-limiting example, module 108 can be used to perform step 308. As discussed in connection with step 224, of FIG. 2A, each one of available processes 210 can use module 108 to retrieve the election information stored in the shared storage location and use the retrieved information to determine which of the available processes 210 successfully elected, or nominated, itself to execute task t₁ by retrieving the election information stored at shared storage location m₁.

In accordance with one or more embodiments, as discussed in connection with step 226 of example 200, each one of the available processes 210 can use module 108 to confirm that self-election is closed and that process p₂ is the self-electing process by writing the signature of p₂ along with the value “FREEZE” in shared storage location m₁.

Referring again to FIG. 3, at step 310, the determined outcome can be used to determine next action. By way of a non-limiting example, step 310 can be performed by iteration completion module 110. In accordance with one or more embodiments, the next action can be an action taken by a process and can depend on whether or not the process successfully self-elected to execute the task identified at step 302. In a case that the process was unsuccessful, the process's action can involve returning to the pool of available processes 210 and participating in a subsequent self-election iteration. In a case that the process successfully self-elected, the process's action can involve executing the task.

As shown in example 200, with reference to FIG. 2B, process p₂ can proceed with executing task t₁ at step 230, while processes p₁ and p₃ can return to a pool of available processes 210 and proceed with a subsequent self-election iteration 234. Although not shown in FIGS. 2A and 2B, after executing task t₁, process p₂ can become one of the available processes 210 participating in a subsequent election iteration 234.

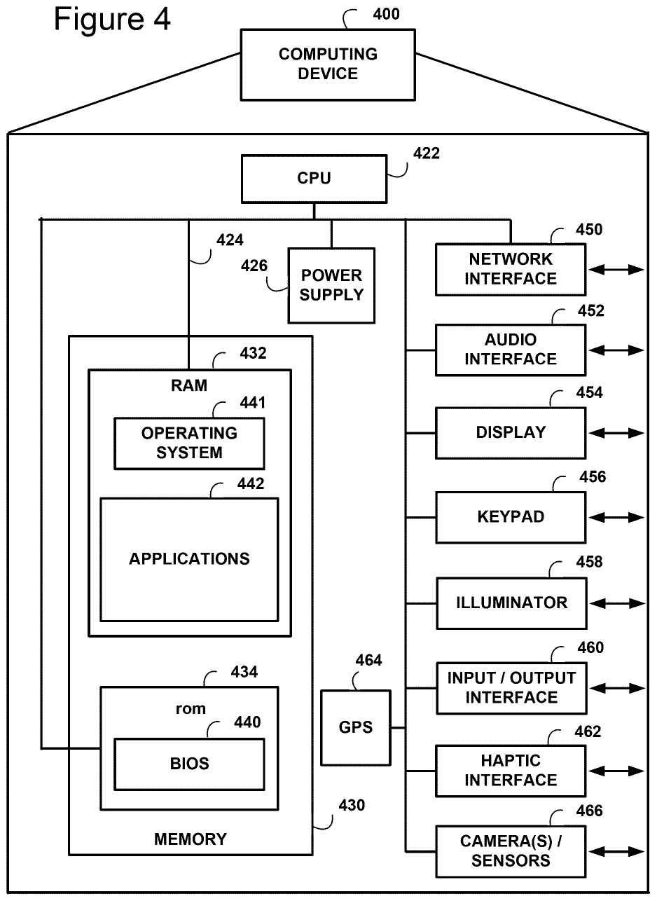

FIG. 4 is a block diagram illustrating a computing device showing an example of a client or server device that can be used to implement functionality described in connection with various embodiments of the disclosure.

The computing device 400 may include more or fewer components than those shown in FIG. 4, depending on the deployment or usage of the device 400. For example, a server computing device, such as a rack-mounted server, may not include audio interfaces 452, display 454, keypads 456, illuminators 458, haptic interfaces 462, GPS receivers 464, or cameras/sensors 466. Some devices may include additional components not shown, such as graphics processing unit (GPU) devices, cryptographic co-processors, artificial intelligence (AI) accelerators, or other peripheral devices.

As shown in FIG. 4, the device 400 includes a central processing unit (CPU) 422 in communication with a mass memory 430 via bus 424. The computing device 400 also includes one or more network interfaces 450, an audio interface 452, a display 454, a keypad 456, an illuminator 458, an input/output interface 460, a haptic interface 462, an optional global positioning systems (GPS) receiver 464 and a camera(s) or other optical, thermal, or electromagnetic sensors 466, and power supply 426. Device 400 can include one camera/sensor 466 or a plurality of cameras/sensors 466. The positioning of the camera(s)/sensor(s) 466 on the device 400 can change per device 400 model, per device 400 capabilities, and the like, or some combination thereof.

In some embodiments, the CPU 422 may comprise a general-purpose CPU. The CPU 422 may comprise a single-core or multiple-core CPU. The CPU 422 may comprise a system-on-a-chip (SoC) or a similar embedded system. In some embodiments, a GPU may be used in place of, or in combination with, a CPU 422. Mass memory 430 may comprise a dynamic random-access memory (DRAM) device, a static random-access memory device (SRAM), or a Flash (e.g., NAND Flash) memory device. In some embodiments, mass memory 430 may comprise a combination of such memory types. In one embodiment, the bus 424 may comprise a Peripheral Component Interconnect Express (PCIe) bus. In some embodiments, the bus 424 may comprise multiple busses instead of a single bus.

Mass memory 430 illustrates another example of computer storage media for the storage of information such as computer-readable instructions, data structures, program modules, or other data. Mass memory 430 stores a basic input/output system (“BIOS”) 440 (e.g., as part of ROM 434) for controlling the low-level operation of the computing device 400. The mass memory also stores an operating system 441 for controlling the operation of the computing device 400.

Applications 442 may include computer-executable instructions which, when executed by the computing device 400, perform any of the methods (or portions of the methods) described previously in the description of the preceding Figures. In some embodiments, the software or programs implementing the method embodiments can be read from a hard disk drive (not illustrated) and temporarily stored in RAM 432 by CPU 422. CPU 422 may then read the software or data from RAM 432, process them, and store them to RAM 432 again.

The computing device 400 may optionally communicate with a base station (not shown) or directly with another computing device. Network interface 450 is sometimes known as a transceiver, transceiving device, or network interface card (NIC).

The audio interface 452 produces and receives audio signals such as the sound of a human voice. For example, the audio interface 452 may be coupled to a speaker and microphone (not shown) to enable telecommunication with others or generate an audio acknowledgment for some action. Display 454 may also include a touch-sensitive screen arranged to receive input from an object such as a stylus or a digit from a human hand.

Keypad 456 may comprise any input device arranged to receive input from a user. Illuminator 458 may provide a status indication or provide light.

The computing device 400 also comprises an input/output interface 460 for communicating with external devices, using communication technologies, such as USB, infrared, Bluetooth™, or the like. The haptic interface 462 provides tactile feedback to a user of the client device.

The optional GPS transceiver 464 can determine the physical coordinates of the computing device 400 on the surface of the Earth, which typically outputs a location as latitude and longitude values. GPS transceiver 464 can also employ other geo-positioning mechanisms, including, but not limited to, triangulation, assisted GPS (AGPS), E-OTD, CI, SAI, ETA, BSS, or the like, to further determine the physical location of the computing device 400 on the surface of the Earth. In one embodiment, however, the computing device 400 may communicate through other components, provide other information that may be employed to determine a physical location of the device, including, for example, a MAC address, IP address, or the like.

The present disclosure has been described with reference to the accompanying drawings, which form a part hereof, and which show, by way of a non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media can tangibly encode computer-executable instructions that when executed by a processor associated with a computing device perform functionality disclosed herein in connection with one or more embodiments.

Computer-readable storage media includes, but is not limited to, RAM, ROM, EPROM, EEPROM, flash memory or other solid-state memory technology, CD-ROM, DVD, or other optical storage, cloud storage, magnetic storage devices, or any other physical or material medium which can be used to tangibly store thereon the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user,” “subscriber,” “consumer,” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
identifying, by each of a number of processes of a number of computing devices, a task awaiting execution;
determining, by each of the number of processes, a shared storage location for the identified task;
updating, by each of the number of processes, the shared storage location determined for the identified task with process identification information uniquely identifying the updating process, each process's update overwriting any process identification information stored in the shared storage location; and
accessing, by each of the number of processes, the shared storage location and retrieving the process identification information stored in the shared storage location, the retrieved process identification information identifying that the process is self-electing execution of the identified task.

2. The method of claim 1, further comprising:
updating the shared storage location in a first self-election stage; and
accessing the shared storage location and retrieving the process identification information stored in the shared storage location in a second self-election stage following the first self-election stage.

3. The method of claim 2, further comprising:
updating, by each of the number of processes, in a third self-election stage following the second self-election stage, the shared storage location determined for the identified task with election information comprising the process identification information identifying the self-electing process and information identifying a shared storage state corresponding to the shared storage location.

4. The method of claim 3, wherein, in the third self-election state, the shared storage state corresponding to the shared storage location indicates that self-election is complete in connection with the identified task.

5. The method of claim 1, wherein updating the shared storage location determined for the identified task further comprises:
updating, by each of the number of processes, the shared storage location determined for the identified task with information identifying a shared storage state corresponding to the shared storage location, the information identifying the shared storage state indicating that self-election has commenced and that at least one of the number of processes has elected itself to execute the identified task.

6. The method of claim 1, further comprising:
confirming, by each of the number of processes, prior to any of the number of processes updating the shared storage location, that self-election has yet to commence in connection with the identified task.

7. The method of claim 6, wherein confirming that self-election has yet to commence in connection with the identified task further comprises:
accessing, by each of the number of processes, the shared storage location and retrieving information stored in the shared storage location indicating that none of the number of processes has nominated itself to execute the identified process.

8. The method of claim 1, wherein determining a shared storage location for the identified task further comprises:
retrieving, by each of the number of processes, information associated with the identified task; and
generating, by each of the number of processes, a hash value corresponding to the shared storage location using at least a portion of the retrieved task information.

9. The method of claim 1, further comprising:
performing a first self-election iteration comprising the number of processes, as a first set of processes, performing the identifying, determining, updated and accessing to identify the process, from the first set of processes, self-electing execution of the identified task, as a first task; and
performing a second self-election iteration for a second task awaiting execution, the second self-election iteration comprising a second set of processes performing the identifying, determining, updating and accessing to identify the process, from the second set of processes, self-electing execution of the second task, the second set of processes comprising at least some of the processes from the first set of processes unsuccessfully self-electing execution in connection with the first iteration.

10. The method of claim 9, further comprising:
performing a third self-election iteration for a third task awaiting execution, the third self-election iteration comprising a third set of processes performing the identifying, determining, updating and accessing to identify the process, from the third set of processes, self-electing execution of the third task, the second set of processes comprising the self-electing process identified in the first self-election iteration, the third self-election iteration occurring after execution of the first task is complete.

11. A non-transitory computer-readable storage medium tangibly encoded with computer-executable instructions that when executed by a number of computing device perform a method comprising:
identifying, by each of a number of processes of the number of computing devices, a task awaiting execution;
determining, by each of the number of processes, a shared storage location for the identified task;
updating, by each of the number of processes, the shared storage location determined for the identified task with process identification information uniquely identifying the updating process, each process's update overwriting any process identification information stored in the shared storage location; and
accessing, by each of the number of processes, the shared storage location and retrieving the process identification information stored in the shared storage location, the retrieved process identification information identifying that the process is self-electing execution of the identified task.

12. The non-transitory computer-readable storage medium of claim 11, the method further comprising:
updating the shared storage location in a first self-election stage; and
accessing the shared storage location and retrieving the process identification information stored in the shared storage location in a second self-election stage following the first self-election stage.

13. The non-transitory computer-readable storage medium of claim 12, the method further comprising:
updating, by each of the number of processes, in a third self-election stage following the second self-election stage, the shared storage location determined for the identified task with election information comprising the process identification information identifying the self-electing process and information identifying a shared storage state corresponding to the shared storage location.

14. The non-transitory computer-readable storage medium of claim 13, wherein, in the third self-election state, the shared storage state corresponding to the shared storage location indicates that self-election is complete in connection with the identified task.

15. The non-transitory computer-readable storage medium of claim 11, wherein updating the shared storage location determined for the identified task further comprises:
updating, by each of the number of processes, the shared storage location determined for the identified task with information identifying a shared storage state corresponding to the shared storage location, the information identifying the shared storage state indicating that self-election has commenced and that at least one of the number of processes has elected itself to execute the identified task.

16. The non-transitory computer-readable storage medium of claim 11, the method further comprising:
confirming, by each of the number of processes, prior to any of the number of processes updating the shared storage location, that self-election has yet to commence in connection with the identified task.

17. The non-transitory computer-readable storage medium of claim 16, wherein confirming that self-election has yet to commence in connection with the identified task further comprises:
accessing, by each of the number of processes, the shared storage location and retrieving information stored in the shared storage location indicating that none of the number of processes has nominated itself to execute the identified process.

18. The non-transitory computer-readable storage medium of claim 11, wherein determining a shared storage location for the identified task further comprises:
retrieving, by each of the number of processes, information associated with the identified task; and
generating, by each of the number of processes, a hash value corresponding to the shared storage location using at least a portion of the retrieved task information.

19. The non-transitory computer-readable storage medium of claim 11, the method further comprising:
performing a first self-election iteration comprising the number of processes, as a first set of processes, performing the identifying, determining, updated and accessing to identify the process, from the first set of processes, self-electing execution of the identified task, as a first task; and
performing a second self-election iteration for a second task awaiting execution, the second self-election iteration comprising a second set of processes performing the identifying, determining, updating and accessing to identify the process, from the second set of processes, self-electing execution of the second task, the second set of processes comprising at least some of the processes from the first set of processes unsuccessfully self-electing execution in connection with the first iteration.

20. A computer system comprising:
at least one processor configured with a number of processes to:
identify, by each of the number of processes, a task awaiting execution;
determine, by each of the number of processes, a shared storage location for the identified task;
updating, by each of the number of processes, the shared storage location determined for the identified task with process identification information uniquely identifying the updating process, each process's update overwriting any process identification information stored in the shared storage location; and
accessing, by each of the number of processes, the shared storage location and retrieving the process identification information stored in the shared storage location, the retrieved process identification information identifying that the process is self-electing execution of the identified task.
